(19) United States
(12) Patent Application Publication
(10) Pub. No.: US 2011/0123149 A1
(43) Pub. Date: May 26, 2011

(54) Fiber Assembly Employing Photonic Band-Gap Optical Fiber

(75) Inventors: Brewster Roe Hemenway Jr, Painted Post, NY (US); Karl William Koch III, Elmira, NY (US); James Gavon Renfro, JR., Pacifica, CA (US)

(73) Assignee: CORNING INCORPORATED, Corning, NY (US)

(21) Appl. No.: 12/993,312

(22) PCT Filed: May 14, 2009
(86) PCT No.: PCT/US2009/002989

§ 371 Date: Jan. 26, 2011

Related U.S. Application Data
(60) Provisional application No. 61/130,482, filed on May 30, 2008.

(51) Int. Cl. G02B 6/42; G02B 6/36; B23P 11/00

(52) U.S. Cl. 385/32; 385/88; 29/428

(57) ABSTRACT

A fiber assembly having at least one photonic band-gap fiber and opto-electronic devices coupled to the at least one fiber at either end. The opto-electronic devices serve as electrical-to-optical (EO) and optical-to-electrical (OE) converters and provide industry-standard electrical interfaces to respective electronic devices. The photonic band-gap fiber has a hollow core so that light travels through air rather than glass, thereby providing a number of advantages over glass-based optical fiber assemblies used to connect electronic devices. A bent optical fiber coupler for use in the fiber assembly is also disclosed.

### CROSS-REFERENCE TO RELATED APPLICATIONS

This application claims the benefit of priority to U.S. Patent Application Ser. No. 61/130,482, filed on May 30, 2008, the content of which is relied upon and incorporated herein by reference in its entirety.

### BACKGROUND OF THE INVENTION

1. Field of the Invention

The present invention relates generally to fiber assemblies, and in particular relates to fiber assemblies employing one or more photonic band-gap optical fibers.

2. Technical Background of the Invention

In the past, electronic devices communicated with other electronic devices via electrical connections. As the need to provide increasing speed and bandwidth to the electrical communication link, different types of high-speed, high-bandwidth electrical cables, such as coaxial cables, were developed.

Now, with the emerging higher speed standards for data and video transmission, such as 10 Gb/s Ethernet, infiniband, High-Definition Multimedia Interface (HDMI) and USB 3.0, there is an increasing the demand for the use of fiber optical cabling to communicate between electrical devices. The use of such cables requires electrical-to-optical (EO) and optical-electrical (OE) conversion at each end of the cable to retain the purely electrical interface to users at either end of the EO/OE system.

While convention optical fibers have larger bandwidths than electrical cables, they also have a number of shortcomings. A first shortcoming is that they have a solid glass core that creates one or more glass-air interfaces that cause reflections. Such reflections introduce optical loss, and also produce unwanted optical feedback. Glass-air interfaces also typically require coupling optics when interfacing the fiber with an opto-electronic device used to perform the EO or OE conversion.

A second shortcoming is that they are not particularly bend-intolerant—that is to say, they can be damaged and/or can cause significant attenuation of the optical signal traveling therethrough when subjected to severe bending, such as imparting a bend radius of 2″ or less. This is inconvenient when EO and OE devices are formed in or on circuit boards located in devices where interior space is at a premium. Conventional optical fibers and their connectors do not allow for readily accessing and connecting to a circuit board housed in the tight confines of most optical and opto-electronic devices because it requires introducing significant bending loss in the optical fibers. This is particularly true where the connection needs to be formed at a right angle with a sufficiently tight radius while maintaining both low loss and high reliability.

What is needed is a fiber assembly that provides a robust communication link between EO and OE devices that does not have the above-mentioned shortcomings associated with conventional optical fiber.

### SUMMARY OF THE INVENTION

A first aspect of the invention is a fiber assembly for optically connecting first and second electrical devices. The assembly includes at least one photonic band-gap optical fiber. First and second opto-electronic devices are respectively coupled to the at least one photonic band-gap optical fiber its respective ends, and configured to perform electrical-to-optical (EO) and/or optical-to-electrical (OE) conversion. First and second electrical interfaces are operably disposed relative to the first and second opto-electronic devices and are configured to provide respective industry-standard electrical connections to the first and second electrical devices.

A second aspect of the invention is a bent optical fiber coupler that includes upper and lower alignment members. The upper fiber alignment member has a concave surface and the lower fiber alignment member has a bottom surface defining a coupler output end, and a convex surface. The lower and upper fiber alignment members are arranged to form a first fiber guide channel defining a first coupler input/output (I/O) end, a channel end, and a central curve defined by said convex and concave surfaces. The coupler also includes at least one photonic band-gap optical fiber having an end portion with a proximal end face. At least a portion of the at least one photonic band-gap fiber is held within the first fiber guide channel so as to form a bend in the at least on photonic band-gap fiber corresponding to the central curve, and to position the fiber end face at or near the bottom surface of the lower fiber alignment member so as to define a second coupler I/O end.

A third aspect of the invention is a method of forming an optical coupler. The method includes providing at least one photonic band-gap optical fiber having an end portion with a proximal end face, and holding the at least one photonic band-gap optical fiber between respective concave and convex surfaces of upper and lower fiber alignment guides so as to form a bend in the at least one photonic band-gap optical fiber. In an example embodiment, the bend is a right-angle bend.

A fourth aspect of the invention is a method of optically connecting first and second electrical device. The method includes providing least one photonic band-gap optical fiber having a hollow core and first and second ends. The method also includes connecting first and second opto-electronic devices to the respective first and second ends of the at least one photonic band-gap optical fiber, wherein the first and second opto-electronic devices are configured to perform electrical-to-optical (EO) and/or optical-to-electrical (OE) conversion. The method further includes operably disposing first and second electrical interfaces relative to the first and second opto-electronic devices so as to provide respective electrical connections between the first and second opto-electronic devices and the first and second electrical devices.

Additional features and advantages of the invention will be set forth in the detailed description that follows, and in part will be readily apparent to those skilled in the art from that description or recognized by practicing the invention as described herein, including the detailed description that follows, the claims, as well as the appended drawings. It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

These and other features, aspects and advantages of the present invention are better understood when the following detailed description of the invention is read with reference to the accompanying drawings, in which:

FIG. 1 is a side view of a section of a photonic band-gap fiber;

FIG. 2 is a cross-sectional schematic view of the photonic band-gap fiber of FIG. 1 taken along the line 2-2;

FIG. 3 is a cross-sectional schematic view of two photonic band-gap structures having different pitches and hole sizes;

FIG. 4 are cross-sectional schematic views of an example method of fabricating the example photonic band-gap fibers used the present invention;

FIG. 5 is a close-up view of an end of a photonic band-gap fiber coupled to a light source, with the numerical aperture (NA) of the optical fiber being greater than that of the light source;

FIG. 6 is a schematic cross-sectional exploded view of an example bent optical fiber coupler according to the present invention that employs one or more photonic band-gap optical fibers;

FIG. 7 is similar to but is an unexploded cross-sectional view and also includes a strain-relief element at one of the input/output (I/O) ends and that also includes an opto-electronic device arranged at the other I/O end;

FIG. 8 is a schematic side view of a photonic band-gap optical fiber illustrating the concept of a right-angle bend in the form of a quarter-round bend in the fiber;

FIG. 9 is a schematic diagram of an opto-electronic assembly that includes the optical fiber coupler of the present invention;

FIG. 10 is similar to FIG. 9 and shows an example opto-electronic device in the form of a VSCEL assembly;

FIG. 11 is a close-up exploded view of the upper and lower alignment members showing a divider member arranged between the concave and convex surfaces to divide the curved fiber guide channel into multiple channels each including a row of photonic band-gap fibers;

FIG. 12A illustrates an example embodiment of the coupler in the process of being fabricated, showing lower alignment member and unbent photonic band-gap fiber positioned to have its end portion inserted into the optical fiber guide in the lower alignment member;

FIG. 12B shows the next step in the example fabrication process wherein the fiber has its end portion inserted into lower alignment member optical fiber guide with the fiber extending vertically therefrom;

FIG. 12C shows the next step in the example fabrication process wherein the fiber is bent to conform to the convex surface portion of the lower alignment member;

FIG. 12D shows the next step in the example fabrication process wherein the upper alignment member is in the form of a curable adhesive applied to the lower alignment member and photonic band-gap fiber thereon so as to form the coupler body;

FIG. 13A is a schematic exploded side view of an example embodiment of an alignment structure used to align the coupler with an opto-electronic device in an opto-electronic assembly;

FIG. 13B shows the alignment structure of FIG. 13A arranged above the opto-electronic device in the form of a VCSEL assembly;

FIG. 14A is a schematic diagram of an example embodiment of communication system that employs a photonic band-gap (PBG) fiber assembly according to the present invention; and

FIG. 14B is similar to FIG. 14A but illustrates an example embodiment of the system that includes the bent optical fiber coupler of FIG. 7.

### DETAILED DESCRIPTION OF THE PREFERRED EMBODIMENTS

Reference is now made to preferred embodiments of the invention, examples of which are illustrated in the accompanying drawings. Whenever possible, the same reference numbers and symbols are used throughout the drawings to refer to the same or like parts. In the description below, terms such as “upper,” “lower,” “front,” “back,” “top,”, “bottom,” “vertical,” “horizontal,” and the like, are relative terms used for the sake of description and are not used in a limiting sense.

### Photonic Band-Gap Fibers

The present invention uses photonic band-gap fibers to form a fiber assembly and to enable a bent optical fiber coupler. Photonic band-gap fibers guide light by a mechanism that is fundamentally different from the total internal reflection mechanism typically used in conventional optical fibers. Photonic band-gap fibers (PBGFs) have a photonic band-gap structure formed in the cladding of the fiber. The photonic band-gap structure may be, for example, a periodic array of holes having a spacing on the order of the wavelength of light. The photonic band-gap structure has ranges of frequencies and propagation constants, known as “band gaps,” for which light is forbidden from propagating in the photonic band-gap structure. The core region of the fiber is formed by a defect in the photonic band-gap structure cladding. For example, the defect may be a hole of a substantially different size and/or shape than the holes of the photonic band-gap structure. Alternatively, the defect may be a solid structure embedded within the photonic band-gap structure. Light introduced into the core will have a propagation constant determined by the frequency of the light and the structure of the core. Light propagating in the core of the fiber having a frequency and propagation constant within a band gap of the photonic band-gap structure will not propagate in the photonic band-gap cladding, and will therefore be confined to the core. A photonic band-gap fiber may have a core region that is formed from a hole larger than those of the surrounding photonic band-gap structure; such a core region is said to be a “hollow core” region. In such a hollow-core fiber, the light may be guided substantially within the hollow core region.

Example photonic band-gap fibers suitable for use in the present invention are described in U.S. Pat. No. 6,243,522, U.S. Pat. No. 6,847,771, U.S. Pat. No. 6,444,133, U.S. Pat. No. 6,788,862, U.S. Pat. No. 6,917,741, U.S. Patent Application Publication No. 2004/0258381, U.S. Patent Application Publication No. 2004/0228592, and PCT Patent Application Publication No. WO 01/37008, all of which are incorporated herein by reference.

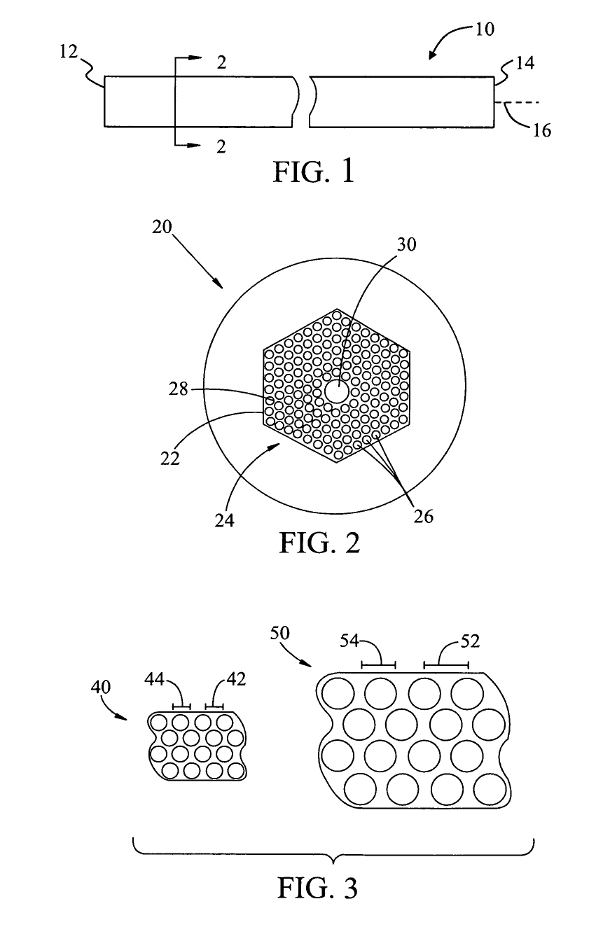

FIG. 1 is a side view of an example embodiment of a section of a photonic band-gap fiber 10 having respective ends 12 and 14 and a central axis 16. FIG. 2 is a cross-sectional schematic view of photonic band-gap fiber 10 suitable for use in the present invention as viewed along 2-2 in FIG. 1. Photonic band-gap fiber 10 includes a photonic band-gap structure 24. In the example embodiment shown in FIG. 2, fiber 10 has a photonic band-gap structure 24 that includes a periodic array of holes 26 formed in a matrix material 28. Though holes 26 of FIG. 2 are schematically depicted as being circular in cross-section, the skilled artisan will recognize that the holes may have any of a number of substantially different cross-sectional shapes.

Photonic band-gap fiber 20 also includes core region 30, which is surrounded by photonic band-gap structure 24 of cladding region 22. In the example of FIG. 2, core region 30 is formed as a hole in matrix material 28. The hole defining core region 30 is much larger than the holes 26 of photonic band-gap structure. As such, core region 30 acts as a defect in photonic band-gap structure 24. Core region 30 may be filled with an inert gas such as nitrogen or argon, air, or a liquid. Core region 30 may also be a region of substantial vacuum (e.g., less than about 20 mm Hg). While core region 30 can be solid, in preferred embodiments of the fiber assembly and bent fiber coupler of the present invention discussed below, core region 30 is hollow.

In an example embodiment, the photonic band-gap fibers used in the present invention guide radiation substantially within core region 30. Radiation introduced into core region 30 has a propagation constant determined by the frequency of the radiation and the structure of the core. Radiation propagating in core 30 and having a frequency and propagation constant within a band gap of the photonic band-gap structure will not propagate in the photonic band-gap structure, and will therefore be substantially confined to the core. As such, the photonic band-gap structure acts as a cladding for the core region. In an example embodiment of the present invention, the photonic band-gap fibers 10 used in the present invention guide radiation having a frequency within a band gap of the photonic band-gap structure substantially within the core region.

Unlike conventional optical fibers, the guidance of radiation in photonic band-gap fibers does not rely on the refractive index of the core being higher than the refractive index of the cladding. Consequently, core region 30 may have a lower effective refractive index than that of the cladding region at the wavelength of the optical energy. As used herein, the effective refractive index of a region is defined as:

$${n}_{eff} = \sqrt{{\sum }_{i = 1}^{z} {f}_{i} \cdot {n}_{i}^{2}}$$

where n_{eff} is the effective refractive index, z is the total number of different refractive indices nᵢ in the photonic band-gap structure, and fᵢ is the volume fraction for refractive index nᵢ The effective refractive index of cladding region 22 will be higher than that of core region 30 due to the presence of matrix material 28. The effective refractive index when the wavelength of light is much larger than the scale of the structure.

As the skilled artisan will appreciate, the exact frequencies spanned by the band gaps of the photonic band-gap structure depend strongly on its structural details. The skilled artisan may adjust the band gap by judicious design of the photonic band-gap structure. Computational methodologies familiar to the skilled artisan may be advantageously used in the design of the photonic band-gap structure. A free software package for the calculation of photonic band-gap structures is available from the Massachusetts Institute of Technology (The MIT Photonic-Bands Package, Internet Uniform Resource Locator http://ab-initio mit.edu/mpb. Dielectric structures having a desired shape and refractive index profile may be defined geometrically. The frequencies and electric and magnetic fields of electro-magnetic modes in a given dielectric structure are calculated by computer solution of the Maxwell equations. A trial solution is constructed by expressing the magnetic field as a sum of plane waves, with arbitrary (random number) coefficients. The Maxwell equations are solved by varying the plane wave coefficients until the electro-magnetic energy is minimized. This is facilitated by a preconditioned conjugate gradient minimization algorithm. The mode frequencies, electric fields, and intensity distributions for each mode are thereby computed. This computational technique is described in more detail in “Block-Iterative frequency-domain methods for Maxwell's equations in a planewave basis,” Johnson, S. J. and Joannopoulos, J. D. Optics Express, 8(3), 173-190 (2001).

The skilled artisan will appreciate that the wavelength range of the band gap scales with the scale of the photonic band-gap structure. For example, as shown in FIG. 3, if a triangular array of holes 40 has a pitch 42 of about 4.7 μm, a hole size 44 of about 4.6 μm, and a band gap ranging in wavelength from about 1400 nm to about 1800 nm, then a scaled triangular array of holes 50 having a pitch 52 of about 9.4 μm, a hole size 44 of about 9.2 μm will have a band gap ranging in wavelength from about 2800 nm to about 3600 nm.

Example photonic band-gap fibers 10 used in the coupler of the present invention as described in detail below may be fabricated using methods analogous to those used in fabricating conventional optical fibers. A preform having the desired arrangement of core and cladding features is formed, then drawn into fiber using heat and tension.

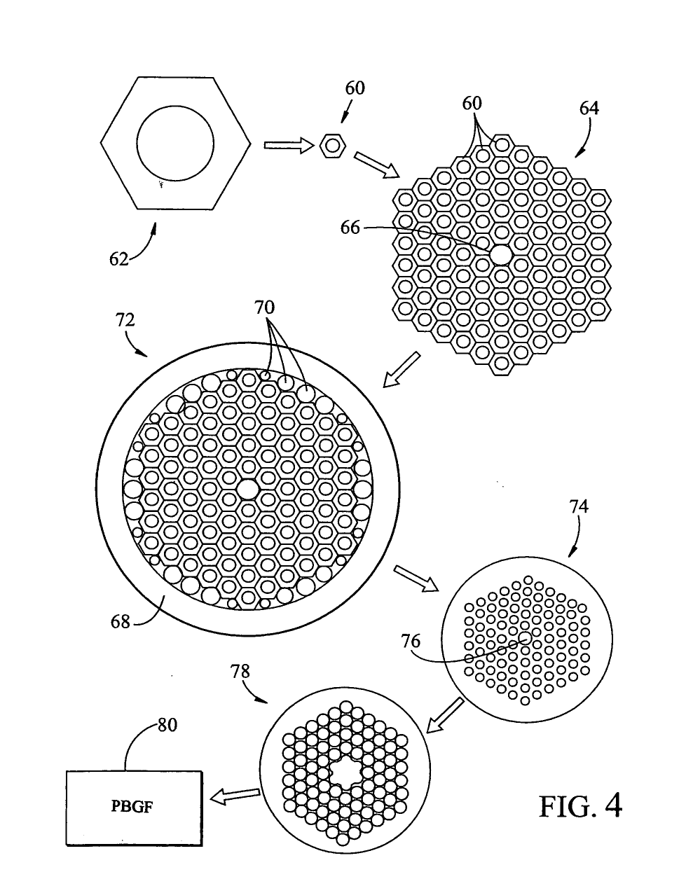

A suitable example method for making a photonic band-gap fiber is shown in cross-sectional detail in FIG. 4. Hollow hexagonal capillaries 60 are made by drawing a hexagonal-sided glass tube 62 using heat and tension. These capillaries are stacked together to form an assembly 64 having a periodic lattice structure. One or more capillaries 60 are removed at the center of assembly 64.

In order to make a hollow-core fiber, a thin tube 66 may optionally be inserted into the hole formed by the removal of the central capillary as shown in FIG. 4. In order to make a solid core fiber, a solid hexagonal rod may be inserted into the hole. Stacked assembly 64 is positioned inside a sleeve tube 68, using solid rods 70 to hold the assembly in place. Sleeved assembly 72 is redrawn using heat and tension to reduce its size, forming a substantially monolithic body 74. It may be desirable to pull a vacuum on the spaces between the stacked capillaries during the redraw step in order to close any interstitial voids between the external surfaces of the capillaries. Body 74 is then etched with NH₄F.HF to increase the sizes of the holes of the periodic array as well as of the hole of the core region. Redraw and etching procedures are described, for example, in the above-cited U.S. Pat. No. 6,444,133. In the etching step, the walls separating the hole 76 of the core region from the innermost course of holes of the photonic band-gap structure are removed, greatly enlarging the size of the hole of the core region. Redrawn, etched body 78 is drawn into a photonic band-gap fiber 80 using methods familiar to the skilled artisan. Before being drawn into fiber, redrawn etched body 76 may be sleeved with an overclad tube (not shown) to provide a fiber with a larger outer diameter. Photonic band-gap fiber 80 may be coated with a primary and secondary optical fiber coating, as is common in the optical fiber art.

It may be desirable to form the preform so that the material of an inner portion of the preform has a higher softening point than the material of an outer portion of the preform, as is described in the above-cited U.S. Pat. No. 6,847,771. For example, the difference in softening points may be about 50° C. or greater, about 100° C. or greater, or even about 150° C. or greater. One way to achieve such a difference is to use silica glass for the capillaries, and a doped silica tube (e.g. germanium doped, fluorine doped, boron doped) as the sleeve tube. Alternatively, glasses with different concentrations of a common dopant can be used in the inner portion and the outer portion of the preform. In cases where a specially-shaped core structure is used, it may be desirable to form the core structure from a material with an even higher softening point (e.g. tantalum-doped silica). Such a difference in softening point allows the inner portion of the preform to be at a somewhat higher viscosity during the draw, leading to less distortion of the inner portion of the structure.

In order to reduce the occurrence of breaks during the draw and lower the level of attenuation in the drawn fiber, it may be desirable to provide a preform having reduced levels of contaminants (e.g. particulate contaminants, organic contaminants, inorganic contaminants) as well as reduced levels of OH content (i.e. surface-adsorbed water). As such, it may be desirable to clean the preform at various stages of manufacture with a chlorine-containing gas (e.g. a mixture of chlorine and helium). As the skilled artisan will recognize, chlorine gas is effective at removing many types of contaminants. For example, chlorine gas may react with water (e.g. in the form of surface OH) and many inorganic contaminants to form volatile species that are removed in a subsequent purge cycle. Chlorine may also act to oxidize various organic species. It may also be desirable to include exposure to oxygen in a cleaning regimen in order to more fully remove organic contaminants. Cleaning processes are described in detail in the above-cited U.S. Pat. No. 6,917,741.

The preforms used in making the optical fiber of the present invention may be made using other methods familiar to the skilled artisan. For example, redraw techniques may be used to reduce the preform diameter. Etching with SF₆, NF₃ or aqueous NH₄F.HF may be used to enlarge the size of the holes. Redraw and etching procedures are described, for example, in the above-cited U.S. Pat. No. 6,444,133.

The preform may be drawn into microstructured optical fiber using methods familiar to the skilled artisan. Additionally, a pressure may be placed on the holes of the preform during the draw in order to keep them from closing due to surface tension. Alternatively, on the end of the preform opposite the drawn end, the holes may be closed in order to maintain a positive pressure inside the holes of the preform, thereby preventing them from closing due to surface tension. It may be desirable to place different pressures on different sets of holes of the preform, as is described in commonly owned U.S. patent application Ser. No. 10/171,335, filed Jun. 12, 2002 and entitled “METHODS AND PREFORMS FOR DRAWING MICROSTRUCTURED OPTICAL FIBERS”, the specification of which is hereby incorporated herein by reference in its entirety. For example, the large core hole of a photonic band-gap fiber may be coupled to a first pressure system, and the holes of the photonic crystal structure may be coupled to a second pressure system. The first pressure system may be set to a lower pressure than the second pressure system so that the inner core hole does not expand relative to the holes of the photonic crystal structure.

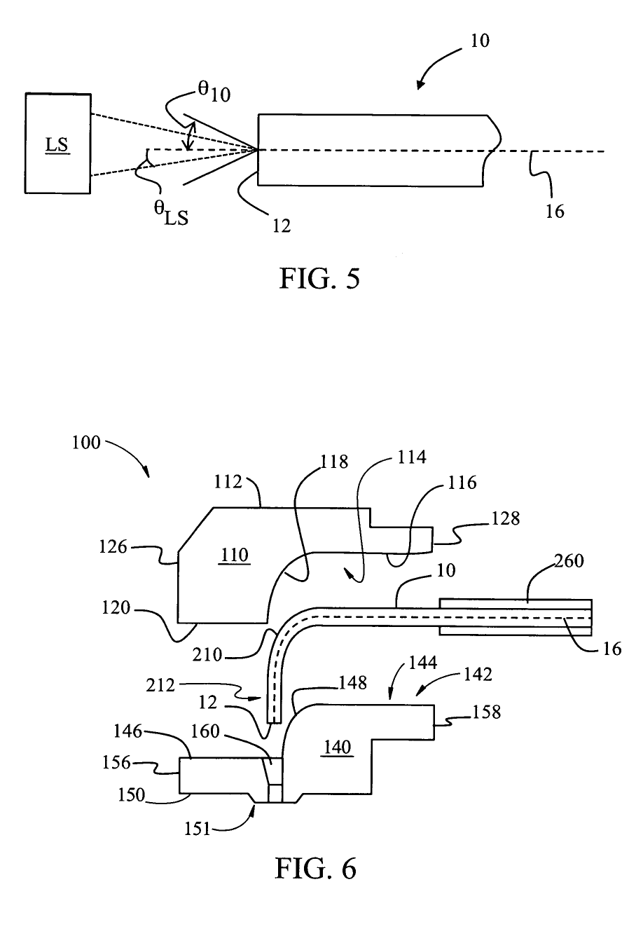

In an example embodiment, the numerical aperture (NA) of photonic band-gap fiber 10 is given by NA₁₀=n sin θ₁₀ and is preferably greater than the numerical aperture NA_{LS}=nsinkₛ of an opto-electronic device in the form of an optical light source LS optically coupled to an end 12 of nano-engineered fiber 10, as shown in FIG. 5. For example, the NA₁₀ of the optical fiber is preferably greater than the NA of a vertical-cavity surface-emitting laser (VCSEL) source.

One important property of photonic band-gap fiber 10 is that it is relatively bend insensitive when compared to conventional optical fibers or even nano-engineered bend-insensitive fibers. In other words, photonic band-gap fiber 10 can have bends with very small bend radii and the light propagating therethrough will not suffer significant attenuation. For example, for a bend radius of 5 mm and a wavelength of 1550 nm, the attenuation is 30-40 dB less than the other types of fibers. Radiation-induced losses are also significantly less for photonic band-gap fibers than for other types of fiber.

### Bent Optical Fiber Coupler

One aspect of the present invention is an optical fiber coupler that employs one or more photonic band-gap optical fibers, wherein the coupler has a severe bend so that connections can be made in tight spaces. FIG. 6 is a schematic cross-sectional exploded view of an example bent optical fiber coupler (“coupler”) 100 that employs one or more photonic band-gap optical fibers 10. Coupler 100 includes an upper alignment member 110 having top surface 112, an “inner” surface 114 that includes a flat portion 116 and a concave curved portion 118. In an example embodiment, concave curved surface 118 comprises a quarter-round curve. Upper alignment member 110 also has a flat bottom surface 120 and front and back ends 126 and 128. In an example embodiment, upper alignment member 110 comprises a pre-formed substrate.

Coupler 100 also includes a lower alignment member 140 having a top surface 142 with an “inner” surface 144 that includes a flat portion 146 and a convex curved portion 148, a bottom surface 150 and front and back ends 156 and 158. In an example embodiment, convex curved surface 148 comprises a quarter-round curve. In an example embodiment, lower alignment member 140 comprises a pre-formed substrate.

Lower alignment member 140 also includes an optical fiber guide 160 located where the flat and curved surface portions 146 and 148 meet and that connects inner surface 144 to bottom surface 150. Optical fiber guide 160 is configured to accommodate one or more photonic band-gap optical fibers 10. In an example embodiment, optical fiber guide 160 includes one or more tapered through-holes that facilitate insertion of fiber(s) 10.

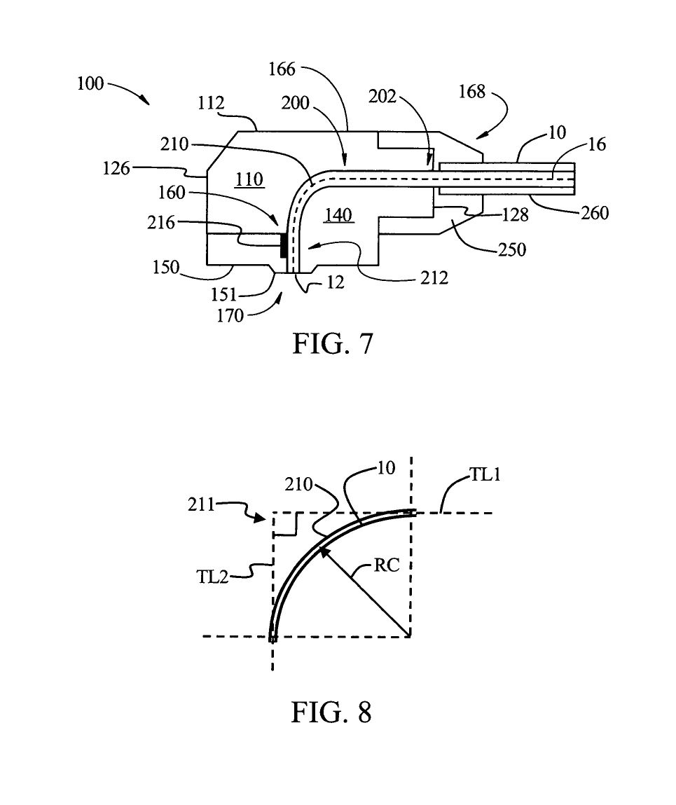

With reference now to FIG. 7, upper and lower alignment members 110 and 140 are brought together to form a coupler body 166 having first and second input/output (I/O) ends 168 and 170 that lie in orthogonal planes. In forming coupler body 166, flat surface portions 116 and 146 of the upper and lower alignment members 110 and 140 come into contact, and respective curved surface portions 118 and 148 are adjacently disposed to define a curved optical fiber guide 200. Optical fiber guide 200 has a first end 202 at first I/O end 168. In an example embodiment, curved optical fiber guide 200 defines a right-angle bend (e.g., quarter-round bend) having central bend radius RC.

Generally, curved optical fiber guide 200 defines a relatively strong bend in fiber 10, such as from between 45° to 135°. FIG. 8 is a schematic side view of a photonic band-gap optical fiber 10 illustrating the concept of a “right-angle bend” in the form of a quarter-round bend 210 in the fiber. Generally, a right-angle bend any bend wherein two tangent lines TL1 and TL2 to the curve intersect to form angle 211 as a right angle. In a preferred embodiment of the invention, concave and convex curved surfaces 118 and 148 are configured to form a right-angle bend 210 in fiber 10, and in an example embodiment are quarter-round curves, i.e., ¼ of the circumference of a circle. In general, curve angle 211 of curve 210 can range from 45° to 135°, with an exemplary right-angle bend being in the range from 85° to 95°. Coupler 100 is shown as being configured to form a right-angle bend in fiber 10 for ease of illustration.

Coupler 100 also includes one or more photonic band-gap optical fibers 10 (hereinafter, simply “fiber 10” for the sake of description) disposed between upper and lower alignment members 110 and 140 within curved optical fiber guide 200. This causes fiber 10 to have corresponding bend 210 that corresponds to central bend radius RC. Fiber 10 has an end portion 212 associated with fiber end face 12. Fiber end portion 212 is contained within optical fiber guide 160 and is preferably held therein with adhesive 216. In an example embodiment, fiber end face 12 is flush with bottom surface 150 of lower alignment member 140.

In one example embodiment, fiber bend 210 can be performed prior to assembly of coupler 100 by laser annealing fiber 10 over a bent μg fixture (which μg may comprise lower alignment member 140 in an example embodiment). This approach minimizes fiber stresses to ensure high reliability over the life of coupler 100. In another example embodiment, fiber bend 210 is formed during assembly of coupler 100, e.g., by bending fiber 10 over curved surface portion 148 of lower alignment member 140 and then placing and securing upper alignment member 110 atop the lower alignment member so that fiber 10 is held in curved optical fiber guide 200. In an example embodiment, grooves or other control features (not shown) form one or both curved surface portions 118 and 148 to facilitate aligning and controlling the bending of fiber 10 within optical fiber guide 160. In an example embodiment, optical fiber guide 160 provides a tight fit to fiber 10 so that the fiber is firmly held therein.

In an example embodiment, central bend radius RC is in the range defined by 1 mm≦RC≦15 mm, while in another example embodiment is within in the range defined 5 mm≦RC≦15 mm, and in another example embodiment is within the range defined by 2 mm≦RC≦3 mm. In example embodiments, the fiber bend radius RC is that which provides an attenuation of not greater than 1 dB, more preferably not greater than 0.5 dB, and most preferably not greater than 0.1 dB. In another example embodiment, the minimum central bend radius RC is four times (4×) the diameter of fiber 10, while in yet another example embodiment, the minimum central bend radius is 4× the diameter of fiber jacket 260 in which fiber 10 is contained. In another example embodiment, bend radius RC is selected to ensure a high reliability (e.g., less than 100 FIT) over the life of the product.

In an example embodiment, alignment of fiber 10 is accomplished by overmolding an additional element (not shown) within the lower fiber alignment member. Such elements include small Si V-groove substrates or other parts with precision slots, grooves, holes or the like.

With continuing reference to FIG. 7, after the upper and lower fiber alignment members 110 and 140 are joined together to contain bent fiber 10 in optical fiber guide 200, a strain relief element 250 is attached to coupler body 166 at first I/O end 168. This is to prevent coupler damage in the case of excessive axial or side-pull loading on fiber 10, which in an example embodiment is encased in a fiber jacket 260 that terminates within strain relief element 250.

### Opto-Electronic Assembly

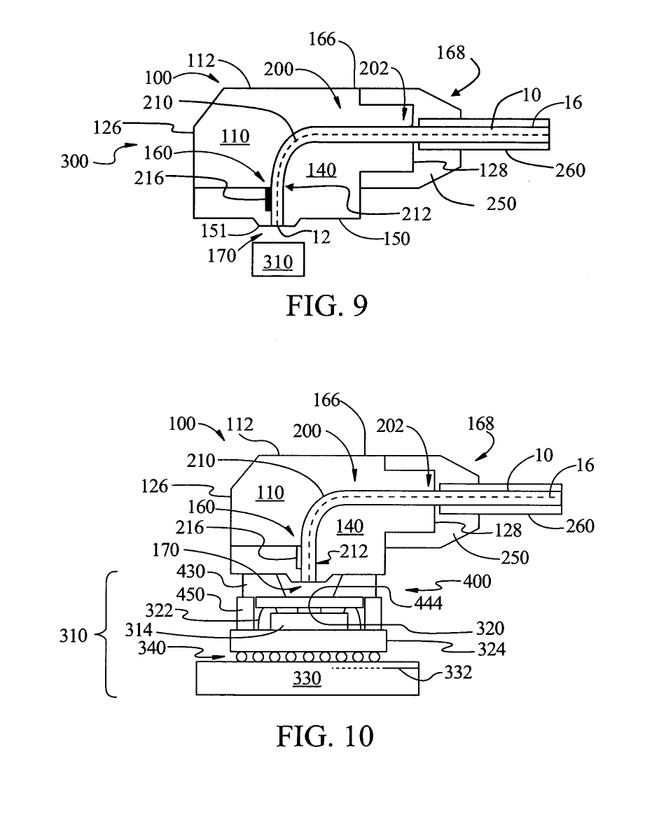

FIG. 9 is a schematic diagram of an opto-electronic assembly 300 that includes coupler 100 of the present invention. Other example embodiments of opto-electronic assembly 300 have a “straight” coupler as discussed below, and coupler 100 is used for the sake of illustration.

Opto-electronic assembly 300 includes an opto-electronic device 310, such as an optical transmitter (e.g., an optical transmitter array, broad-area emitter, etc.) or an optical detector (e.g., an optical detector array, broad-area detector, vertical-cavity surface-emitting laser (VCSEL), LED, etc.). In an example embodiment, fiber 10 is directly optically coupled at end face 12 to opto-electronic device 310 without intermediate coupling optics, which is one of the advantages of a hollow-core photonic band-gap fiber. Fiber end face 12 can be positioned within optical fiber guide 160 so that it is flush with bottom 150. Alternatively, fiber end face 12 can be allowed to protrude from fiber guide 160.

In an example embodiment, the bottom surface 150 of lower alignment member 140 includes a projection 151 at second I/O end 170 (see also FIG. 6). In an example embodiment, projection 151 is sufficiently narrow to allow the fiber end face 12 to be positioned in close proximity to opto-electronic device 310 without interfering with other items or components, such as wire bonds in the opto-electronic device.

In an example embodiment mentioned above, opto-electronic device 310 comprises a broad area optical detector, which like a VCSEL, is commonly implemented using planar fabrication processes. Also like a VCSEL, the detector active area can be optimized to provide low-loss fiber-to-detector coupling as well as high device data rates. The planar process enables 1 D or 2 D layouts and co-location of detector amplification circuitry for high-speed device operation.

Typical opto-electronic devices 310 are packaged using well-established packaging techniques. For example, device substrates are commonly used, with the substrate arranged parallel to the package mounting surface (e.g., a printed circuit board). This configuration is desirable for efficient thermal management of the opto-electronic component, and it also enables standard low-cost electrical interconnection methods (e.g., wire bonding). In the case of optical devices, the configuration also enables relatively simple testing prior to final assembly. Examples of such packing are discussed below.

FIG. 10 is similar to FIG. 9 and shows an example opto-electronic device 310 in the form of a VSCEL assembly (also referred to as 310) used as, for example, an EO transmitter. VCSELS are well-suited for low-loss coupling into photonic band-gap fibers, and the emission area of a VCSEL can be modified to maximize coupling efficiency while also balancing other requirements such as maximum data rate and power dissipation. The planar fabrication process enables dense VCSEL layouts in 1-dimensional (1 D) or 2-dimensional (2 D) arrays and co-location of laser drive circuitry for high-performance operation.

VCSEL assembly 310 includes a VCSEL substrate 314 that operably supports a VCSEL device 320. VCSEL substrate 314 is supported by a package substrate 324 that includes electrical structure including electrical vias (not shown) that is electrically connected to VCSEL device 320 via bond wires 322. A printed circuit board 330 with electrical wiring 332 is connected to package substrate and electrical vias (not shown) via a ball grid array 340. An alignment structure 400 is used in an example embodiment to align and otherwise operably couple coupler 100 to VCSEL assembly 310.

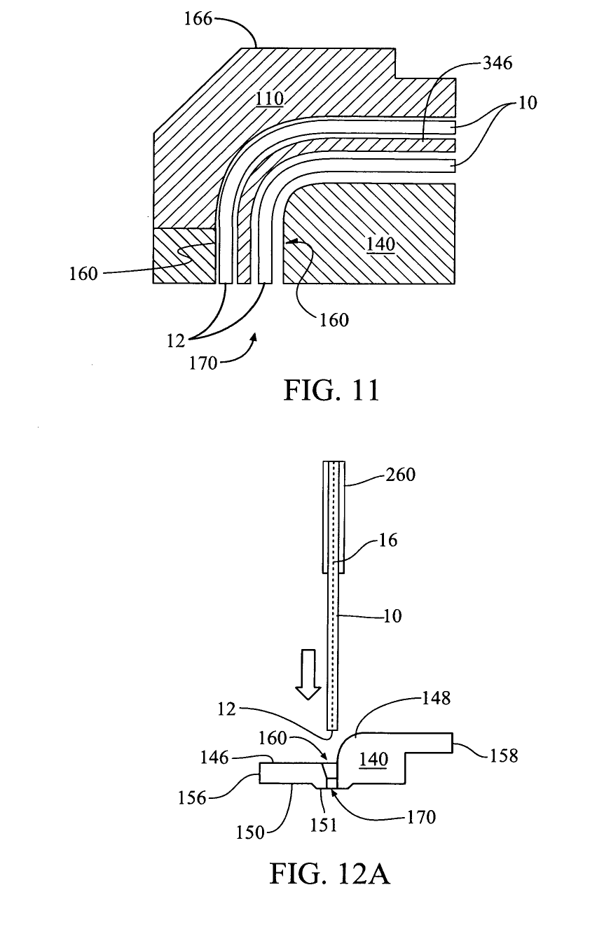

It is noted here that the cross-sectional views of coupler 100 presented herein depict a 1-dimensional array of one or more fibers 10 by way of illustration. Two-dimensional arrays are also contemplated by the present invention. With reference to FIG. 11, such embodiments may be formed, for example, by providing at least one alignment member and/or spacer (“divider member”) 346 to offset each 1-D row of fibers 10 from neighboring rows. Lower alignment member 140 includes multiple optical fiber guides 160 to accommodate the multiple rows of fibers 10. The 2-D array pattern may included non-regular fiber waveguide pitches or 2-D patterns with some amount of skew to maximize optical coupling with the opto-electronic device 310.

### Coupler Fabrication Methods

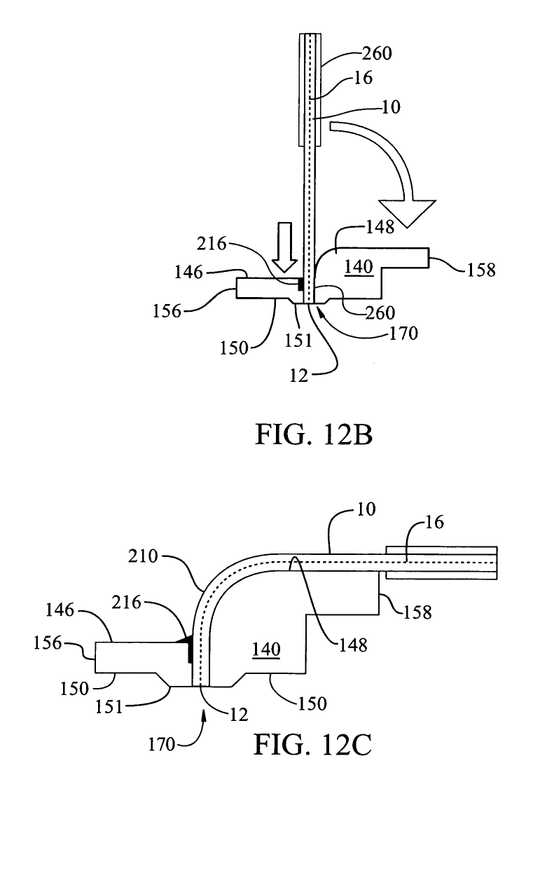

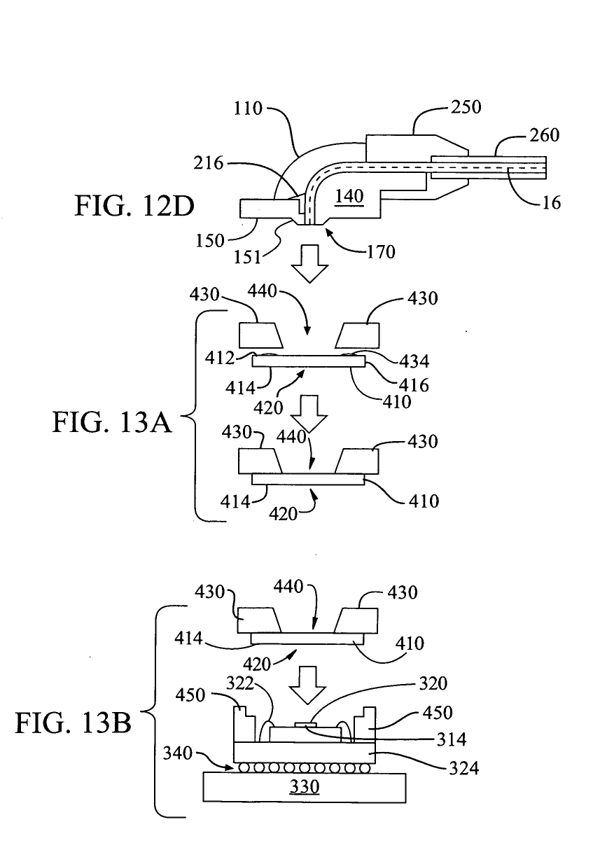

FIG. 12A illustrates an example embodiment of coupler 100 in the process of being fabricated, showing lower alignment member 140 and a yet unbent photonic band-gap fiber 10 positioned to have its end portion 12 inserted into optical fiber guide 160. In FIG. 12B, fiber 10 has its end portion 12 inserted into optical fiber guide 160 and the fiber extends vertically therefrom. An adhesive 370 (e.g., an ultra-violet (UV) curable adhesive) is used to secure fiber 10 within optical fiber guide 160.

FIG. 12C shows fiber 10 after it is bent (see arrow 376 of FIG. 12B) so as to be positioned along curved surface portion 148 of lower alignment member 140. With reference to FIG. 12D, an adhesive (e.g., a UV-curable adhesive) is applied to lower alignment member 140 and fiber 10 supported thereby so as to form upper alignment member 110 and curved optical fiber guide 200. Strain relief element 250 is then optionally attached (e.g., using an adhesive) to a coupler body I/O end 168.

FIG. 13A is a schematic exploded side view of an example embodiment of an alignment structure 400 used to align coupler 100 with opto-electronic device 310. Alignment structure 400 includes a substrate 410 having upper and lower surfaces 412 and 414 and a periphery 416. In an example embodiment, substrate 410 includes a transparent center portion (or alternatively, an aperture) 420. The alignment structure includes at least one alignment member (e.g., a cap) 430 arranged atop substrate upper surface 412 (e.g., via an adhesive 434) so as to form an opening 440 sized to receive coupler I/O end 170 and align fiber 10 therein with opto-electronic device 310.

FIG. 13B shows alignment structure 400 arranged above opto-electronic device 310 in the form of a VCSEL assembly. FIG. 10 discussed above shows alignment structure 400 in place on VCSEL assembly 310 and coupler 100 engaged with the alignment structure. In an example embodiment, alignment structure 400 is aligned and attached to opto-electronic device 310. The alignment process may be active or passive, depending on alignment tolerances. Note that in FIG. 13B alignment structure 400 is integrated into the opto-electronic assembly 300 by way of support elements 450 connected to package substrate 324.

Alignment member 430 may be formed, for example, by bonding a preformed member onto substrate 410. The alignment member 430 can be a molded part or formed from a silicon substrate fabricated by through-wafer KOH etching.

Once alignment structure 400 is properly arranged relative to opto-electronic device 310 (and if necessary, attached thereto), coupler 100 is aligned to the alignment structure and engaged therewith. Coupler 100 may be temporarily held in place via latching elements (not shown) or permanently held in place using thin layers of adhesive 460 in and/or around alignment member 430.

Communication System with Photonic Band-Gap Fiber Assembly

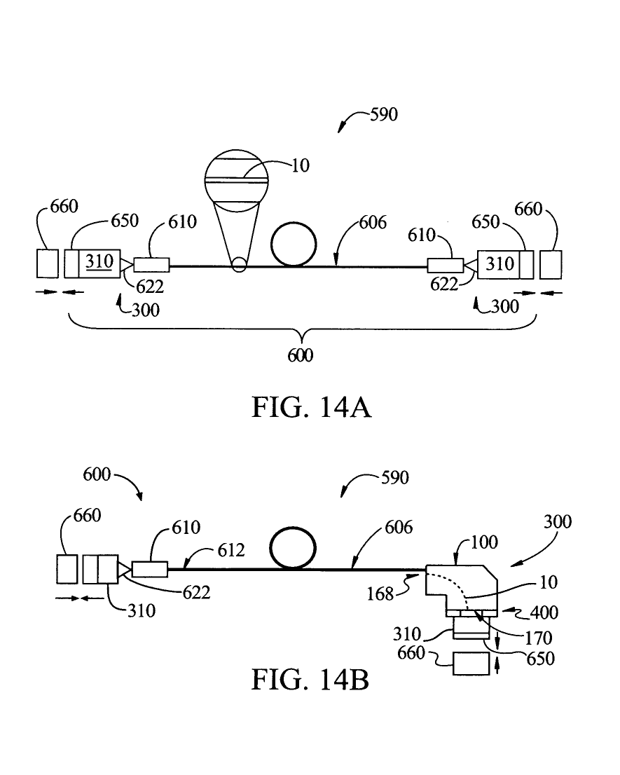

FIG. 14A is a schematic diagram of an example embodiment of a communication system 590 that employs a photonic band-gap (PBG) fiber assembly 600 according to the present invention that allows for optically communication between two electrical devices 660. PBG fiber assembly 600 includes one or more hollow-core photonic band-gap fibers 10, which in an example embodiment constitute a fiber-optic cable 606. In an example embodiment, multiple photonic band-gap fibers 10 are arranged as a fiber ribbon.

Cable 606 includes respective couplers (connectors) 612 at its opposite ends. PBG fiber assembly 600 includes opto-electronic devices 310 arranged at the respective cable ends and configured to serve as EO/OE converters at their respective ends (i.e., each opto-electronic device 310 can perform EO and OE conversions). In another example embodiment, one of opto-electronic devices 310 serves only as an EO converter while the other serves as an OE converter. The combination of connectors 612 and opto-electronic devices 310 constitute the aforementioned opto-electronic assemblies 300. In an example embodiment illustrated in FIG. 14B, one of connectors 612 is bent optical coupler 100 as discussed in detail above.

In an example embodiment, one or both opto-electronic assemblies 300 present an industry-standard copper connection (interface) 650 (e.g., SFP, MTF, USB, etc.) to electronic devices 660 at one or both ends of PBG fiber assembly 600. In example embodiments, interface 650 is fixed or removable.

In the operation of communication system 590, one of the opto-electronic devices 310 initially serves as an EO converter and receives an input electronic signal from electronic device 660 via interface 650. This opto-electronic device 310 then converts the electronic signal to an output optical signal 622, which is coupled into the one or more hollow cores 30 of one or more fibers 10 via connector 612. Connector 612 and transmitter 310 are shown separated for the sake of illustration; they can also be in contact via compression fitting, epoxy or other fixing means. Optical signal 622 is guided by the one or more hollow cores 30 in the one or more fibers 10 in fiber optic cable 606 to the other connector 612 (e.g., coupler 100 of FIG. 14B) wherein the light signals are then received by opto-electronic device 310. This opto-electronic device 310 then acts as an OE converter to convert the detected optical signals to electrical signals, which are then provided to electronic device 660 via interface 650. In an example embodiment, this process is repeated in reverse by the opto-electronic devices 310 switching their EO and OE functions.

PBG fiber assembly 600 provides a number of advantages over assemblies that employ conventional optical fiber. First, light propagation in the hollow core region eliminates the need for optical sub-components used in conventional cable assemblies to focus and convert laser output from its natural “in air” state beam pattern to a beam pattern appropriate for solid glass optical fibers and vice versa. It also eliminates a number of glass-air interfaces that cause loss and optical feedback due to reflection at glass-air interfaces in conventional cable assemblies. This also enables the use of isolator-free implementations.

Further, because of the use of photonic band-gap fiber 10, cables 606 are more robust and in particular can be severely bent without incurring damage or optical loss. This means the cables can be made with less armor and overall bulk. In additional, the use of photonic band-gap fibers 10 provides enhanced optical isolation as compared to conventional fibers, so that the fibers can be densely bundled. The radiation resistance characteristics of photonic band-gap fibers 10 make PBG fiber assembly 600 suitable for use in a number of harsh environments, such as space and nuclear reactors.

Finally, the bend-insensitivity of photonic band-gap fibers 10 allow for a bent coupler 100 to impart a strong bend to the fibers so that PBG cable 606 can be connected to opto-electronic devices in tight spaces.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A fiber assembly for optically connecting first and second electrical devices, comprising:
at least one photonic band-gap optical fiber;
first and second opto-electronic devices respectively coupled to the at least one photonic band-gap optical fiber at its respective ends and configured to perform electrical-to-optical (EO) and/or optical-to-electrical (OE) conversion; and
first and second electrical interfaces operably disposed relative to the first and second opto-electronic devices and configured to provide respective electrical connections to the first and second electrical devices.

2. The fiber assembly of claim 1, wherein the at least one photonic band-gap optical fiber includes a plurality of photonic band-gap fibers arranged in a ribbon.

3. The fiber assembly of claim 1, wherein the at least one photonic band-gap optical fiber has a hollow core.

4. The fiber assembly of claim 1, wherein at least one end of the at least one photonic band-gap optical fiber includes an optical fiber coupler having a bend.

5. The fiber assembly of claim 4, wherein the bend is a right-angle bend.

6. The fiber assembly of claim 4, wherein the optical fiber coupler comprises:
an upper fiber alignment member having a concave surface;
a lower fiber alignment member having a bottom surface defining a coupler output end, and a convex surface, the lower and upper fiber alignment members arranged to form a first fiber guide channel defining a first coupler input/output (I/O) end, a channel end, and a central curve defined by said convex and concave surfaces; and
wherein the at least one photonic band-gap optical fiber has an end portion with a proximal end face, with at least a portion of the at least one photonic band-gap fiber held within the first fiber guide channel so as to form a central bend in the at least one photonic band-gap fiber corresponding to said central curve, and to position the fiber end face at or near the bottom surface of the lower fiber alignment member so as to define a second coupler (I/O) end.

7. The fiber assembly of claim 6, wherein the lower fiber alignment member includes a second fiber guide channel adjacent the first fiber guide channel end and open to the bottom surface and configured to hold the fiber end portion.

8. The fiber assembly of claim 1, wherein at least one of the first and second opto-electronic device comprises a vertical cavity surface emitting laser (VCSEL).

9. The assembly of claim 1, wherein at least one of the first and second opto-electronic devices includes at least one active surface, and further including:
an alignment structure disposed between the fiber optic cable and the at least one active surface and configured to provide optical alignment between the at least one photonic band-gap fiber and the at least one active surface.

10. A bent optical fiber coupler comprising:
an upper fiber alignment member having a concave surface;
a lower fiber alignment member having a bottom surface defining a coupler output end, and a convex surface, the lower and upper fiber alignment members arranged to form a first fiber guide channel defining a first coupler input/output (I/O) end, a channel end, and a central curve defined by said convex and concave surfaces; and
at least one photonic band-gap optical fiber having an end portion with a proximal end face, with at least a portion of the at least one photonic band-gap fiber held within the first fiber guide channel so as to form a bend in the at least on photonic band-gap fiber corresponding to said central curve, and to position the fiber end face at or near the bottom surface of the lower fiber alignment member so as to define a second coupler I/O end.

11. The coupler of claim 10, wherein the lower fiber alignment member includes a second fiber guide channel adjacent the first fiber guide channel end and open to the bottom surface and configured to hold the fiber end portion.

12. The coupler of claim 10, wherein at least one of the convex and concave surfaces comprises a right-angle bend.

13. The coupler of claim 10, wherein the at least one photonic band-gap optical fiber is surrounded by an outer jacket, the coupler further including:
a strain relief member arranged at the first coupler I/O end so as to surround the outer jacket to provide strain relief to the at least one photonic band-gap optical fiber.

14. The coupler of claim 10, wherein the upper fiber alignment member comprises at least one of a molded substrate and a cured adhesive.

15. The coupler of claim 10, wherein the lower fiber alignment member comprises a molded substrate.

16. The fiber assembly of claim 8, wherein the at least one photonic band-gap fiber has a diameter, and wherein the bend in the at least on photonic band-gap fiber has minimum central bend radius of four times (4×) the diameter.

17. The coupler of claim 10, further including a divider member arranged within the first fiber guide channel so as to divide the channel into a plurality of channels each containing at least one photonic band-gap optical fiber.

18. A method of forming an optical coupler comprising:
providing at least one photonic band-gap optical fiber having an end portion with a proximal end face;
holding the at least one photonic band-gap optical fiber between respective concave and convex surfaces of upper and lower fiber alignment guides so as to form a bend in the at least one photonic band-gap optical fiber.

19. The method of claim 18, wherein the bend does not cause an attenuation of greater 1 dB.

20. The method of claim 18, further including:
bending the at least one photonic band-gap optical fiber over the concave surface of the lower alignment guide;
applying a curable adhesive layer to the concave surface and the at least one photonic band-gap fiber so as to form the upper alignment member; and
curing the curable adhesive layer.

21. The method of claim 18, further including optically coupling the fiber proximal end face to a first opto-electronic device.

22. The method of claim 21, wherein the at least one photonic band-gap optical fiber has a distal end face and further including optically coupling the distal end face to a second opto-electronic device.

23. A method of optically connecting first and second electrical devices, comprising:
providing least one photonic band-gap optical fiber having a hollow core and first and second ends;
connecting first and second opto-electronic devices to the respective first and second ends of the at least one photonic band-gap optical fiber, wherein the first and second opto-electronic devices are configured to perform electrical-to-optical (EO) and/or optical-to-electrical (OE) conversion; and
operably disposing first and second electrical interfaces relative to the first and second opto-electronic devices so as to provide respective electrical connections between the first and second opto-electronic devices and the first and second electrical devices.

24. The method of claim 23, wherein said connecting includes providing at least one connector configured to hold the at least one photonic band-gap fiber so that the at least one photonic band-gap fiber has a bend.

25. The method of claim 23, further including providing multiple photonic band-gap fibers arranged in a fiber-optic cable, or arranged in one or more rows of fiber ribbons.
